(19) United States
(12) Patent Application Publication
(10) Pub. No.: US 2023/0196344 A1
(43) Pub. Date: Jun. 22, 2023

(54) SYSTEM AND METHOD FOR PROVIDING WEBPAGES AS UNIQUE ASSET TOKENS

(71) Applicants: Charles RAFFAY, Jensen Beach, FL (US); Costan CAYME, Kidapawan City (PH); Angelo Carlo Cruz CARLOS, Bulacan City (PH); John Carlo Aguimod MAMOSOG, Davao City (PH); Darlene FALLAS, Long Island, NY (US)

(72) Inventors: Charles RAFFAY, Jensen Beach, FL (US); Costan CAYME, Kidapawan City (PH); Angelo Carlo Cruz CARLOS, Bulacan City (PH); John Carlo Aguimod MAMOSOG, Davao City (PH); Darlene FALLAS, Long Island, NY (US)

(21) Appl. No.: 17/644,712

(22) Filed: Dec. 16, 2021

(51) Int. Cl. G06Q 20/38; G06Q 20/36; G06Q 20/06

(52) U.S. Cl. CPC G06Q 20/38215; G06Q 20/3825; G06Q 20/3827; G06Q 20/363; G06Q 20/065

(57) ABSTRACT

Techniques for encoding assets owned via tokens as webpages. A method includes encoding a webpage associated with unique assets into portions of code. Each of portion of code causes projection of media content corresponding to the unique assets when executed. The method also includes creating a database including at least webpage nodes and unique asset token (UAT) nodes, wherein the encoded portions of code are stored among the nodes, one of the webpage nodes is associated with the webpage, one or more of the UAT nodes is connected to the webpage node that is associated with the webpage, and each of the UAT nodes corresponds to one of the unique assets. The method also includes providing the portions of code to a device authorized by an owner of the UAT node connected to the webpage node that is associated with the webpage.

### TECHNICAL FIELD

The present disclosure relates generally to unique asset tokens such as non-fungible tokens (NFTs), and more specifically to providing webpages as unique asset tokens.

### BACKGROUND

A non-fungible token (NFT) is a non-interchangeable unit of data associated with an asset such as a physical or digital item. Because NFTs are unique, they can be utilized to provide data scarcity even for data that is easily replicated. Thus, owning an NFT can provide the ability to own data uniquely (i.e., such that only a single person or entity owns that data) or semi-uniquely (such as when a limited group of people each own a copy of the data). NFTs typically cannot be copied or transferred without permission, and can serve as a proof of authenticity as well as a means for accessing the owned assets.

Existing solutions for providing NFTs record transactions involving transfers of NFTs to a blockchain. A blockchain is a distributed digital ledger storing transaction data, where the distributed ledger is stored on multiple nodes such that each node is a computer storing a copy of the blockchain. Because copies of the blockchain are stored across multiple nodes, records cannot be altered on one node in order to falsify the records among the nodes. When new transaction data is to be added to the blockchain, the nodes validate the new transaction data and reach consensus regarding what data should be included in the updated blockchain. When such consensus occurs, transaction data is recorded on the blockchain on each node.

According to existing solutions, when an NFT is transferred, the ability to access the NFT may be provided via a wallet storing data about the NFT that was transferred as recorded on the blockchain. The wallet is a device or program storing the ownership data and including code for managing and transferring ownership of digital assets such as NFTs and cryptocurrencies.

With the increasing use of blockchain technology and an explosion of growth of NFT usage, new techniques for using and creating NFTs are in high demand. The majority of NFT work in development has focused on the typical use case demonstrated by existing solutions, but existing solutions barely scratch the surface of the potential of this emerging technology. Thus, it would be advantageous to provide techniques for creating and using NFTs in new ways.

Further, some existing solutions allow for associating web content with user accounts. However, these associations are static and cannot be readily changed. Accordingly, such existing solutions do not permit transferring or severing connections to web content without reconfiguring the code of the webpages or otherwise altering the website including the webpage.

Additionally, as noted above, existing NFT solutions require use of blockchains. It would therefore further be advantageous to provide NFT solutions which are blockchain-agnostic.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for encoding assets owned via tokens as webpages. The method comprises: encoding a webpage into at least one portion of code, wherein the webpage is associated with at least one unique asset, wherein each of portion of code causes projection of media content corresponding to the at least one unique asset when executed; creating a database including a plurality of nodes, the plurality of nodes including a plurality of webpage nodes and a plurality of unique asset token (UAT) nodes, wherein the encoded at least one portion of code of the webpage is stored among a portion of the plurality of nodes, wherein a first webpage node of the plurality of webpage nodes is associated with the webpage, wherein at least one first UAT node of the plurality of UAT nodes is connected to the first webpage node, wherein each of the at least one first UAT node corresponds to one of the at least one unique asset; and providing the at least one portion of code to a device authorized by an owner of the at least one first UAT node.

Certain embodiments disclosed herein also include a non-transitory computer readable medium having stored thereon causing a processing circuitry to execute a process, the process comprising: encoding a webpage into at least one portion of code, wherein the webpage is associated with at least one unique asset, wherein each of portion of code causes projection of media content corresponding to the at least one unique asset when executed; creating a database including a plurality of nodes, the plurality of nodes including a plurality of webpage nodes and a plurality of unique asset token (UAT) nodes, wherein the encoded at least one portion of code of the webpage is stored among a portion of the plurality of nodes, wherein a first webpage node of the plurality of webpage nodes is associated with the webpage, wherein at least one first UAT node of the plurality of UAT nodes is connected to the first webpage node, wherein each of the at least one first UAT node corresponds to one of the at least one unique asset; and providing the at least one portion of code to a device authorized by an owner of the at least one first UAT node.

Certain embodiments disclosed herein also include a system for encoding assets owned via tokens as webpages. The system comprises: a processing circuitry; and a memory, the memory containing instructions that, when executed by the processing circuitry, configure the system to: encode a webpage into at least one portion of code, wherein the webpage is associated with at least one unique asset, wherein each of portion of code causes projection of media content corresponding to the at least one unique asset when executed; create a database including a plurality of nodes, the plurality of nodes including a plurality of webpage nodes and a plurality of unique asset token (UAT) nodes, wherein the encoded at least one portion of code of the webpage is stored among a portion of the plurality of nodes, wherein a first webpage node of the plurality of webpage nodes is associated with the webpage, wherein at least one first UAT node of the plurality of UAT nodes is connected to the first webpage node, wherein each of the at least one first UAT node corresponds to one of the at least one unique asset; and provide the at least one portion of code to a device authorized by an owner of the at least one first UAT node.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2A is a visual depiction of nodes in a database realized as a hypergraph.

FIG. 2B is a visual depiction of nodes in a database including a token series node.

FIG. 3 is a flowchart illustrating a method for providing webpages as unique asset tokens according to an embodiment.

FIG. 4 is a flowchart illustrating a method for creating a unique asset token database according to an embodiment.

FIG. 5 is a flowchart illustrating a method for transferring unique asset token nodes of webpages using a database according to an embodiment.

FIG. 6 is a visual depiction of nodes in a database utilized to describe implementing a multi-ownership wallet.

FIG. 7 is a schematic diagram of a web content provider according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include methods and systems for providing webpages as unique asset tokens (UATs) such as, but not limited to, non-fungible tokens (NFTs) or provenance and documentation tokens (PDTs). The disclosed embodiments can be utilized to tokenize unique assets included in or represented by web content. More specifically, various disclosed embodiments involve encoding a webpage into one or more portions of code that include instructions for displaying media content of the webpage, and tokenizing the encoded webpage by creating nodes representing the webpage as well as nodes representing UATs indicating ownership of the unique assets associated with the webpage.

In an embodiment, a request to mint a webpage as a UAT is received. The webpage to be minted is encoded into one or more portions of code including code for projecting media content of the webpage. A database is created or updated such that the database includes at least one or more webpage nodes representing the webpage and one or more UAT nodes representing UATs that indicate ownership of a respective unique asset captured in the media content of the webpage. The portions of the webpage are distributed among nodes in the database. The webpage (or a portion thereof) may represent a digital asset such as a music or video file and may include the digital asset or a portion thereof. Alternatively or collectively, the webpage may represent a physical asset such as a book or art piece and may include media content representing the underlying physical asset or which can be utilized to access the underlying physical asset.

Once the database including the webpage nodes and the UAT nodes is created or updated, the database may optionally be stored on a decentralized ledger such as a blockchain. Further, at any point after the database is created or updated, the UAT nodes may be transferred (thereby transferring the UATs represented by the UAT nodes) by altering connections between nodes in the database, thereby further updating the database.

When a user associated with a given UAT node (e.g., a user of a wallet represented by a wallet node connected to the UAT node in the database) desires to access web content of the UAT node, the user may request that such web content be provided. This request may require some form of authentication, for example, via a wallet device or application associated with the UAT node. The requested web content is provided to a device authorized by the user such as, but not limited to, a user device operated by the user. Specifically, the respective portions of code of the web content to be accessed are provided. When these portions of code are executed on the user device, the user device becomes configured to project media content of the web content. This allows the user to access the media content of the tokenized webpage.

The disclosed embodiments utilize encoded portions of the web-based content tokenized as nodes in a database in order to effectively enable providing webpages as NFTs or other non-interchangeable tokens. More specifically, the disclosed embodiments provide techniques which manipulate interactions with the Internet in order to provide web content as UATs, namely, by encoding webpages, distributed the encoding webpages among the database, and connecting webpage nodes representing the encoded webpages to respective UAT nodes representing ownership of a webpage or portion thereof as a UAT.

The disclosed embodiments further provide techniques for utilizing various nodes in order to allow for modular enforcement of various policies related to creation of tokens, use of tokens, access to tokens, and the like. These various nodes therefore allow for enforcing policies and controlling access to web content owned via UATs.

Additionally, various disclosed embodiments allow for providing new functionality for digital tokens such as NFTs or otherwise include new techniques for providing such functionality. Such new functionality may include, but is not limited to, allowing for multi-ownership wallets in which multiple entities are assigned ownership of a single jointly owned wallet, tokenizing discrete sections of the same webpage, aggregating content from multiple webpages of commonly owned tokens into a single webpage, and the like.

Various disclosed embodiments further allow for providing NFTs or other tokens representing unique assets without requiring transfers involving the NFTs to be recorded on a blockchain. In some embodiments, UAT nodes included in a database as described herein can be recorded in a centralized database regardless of whether such nodes are also stored on a blockchain. Storing the tokens in a centralized database also provides portability, thereby allowing token records to be transferred to a new blockchain as needed. In this regard, it is noted that recording tokens in both a centralized database and a decentralized data structure such as a blockchain allows for providing this portability for centralized records while providing an immutable ledger that can be utilized to validate accuracy of records stored in the centralized database.

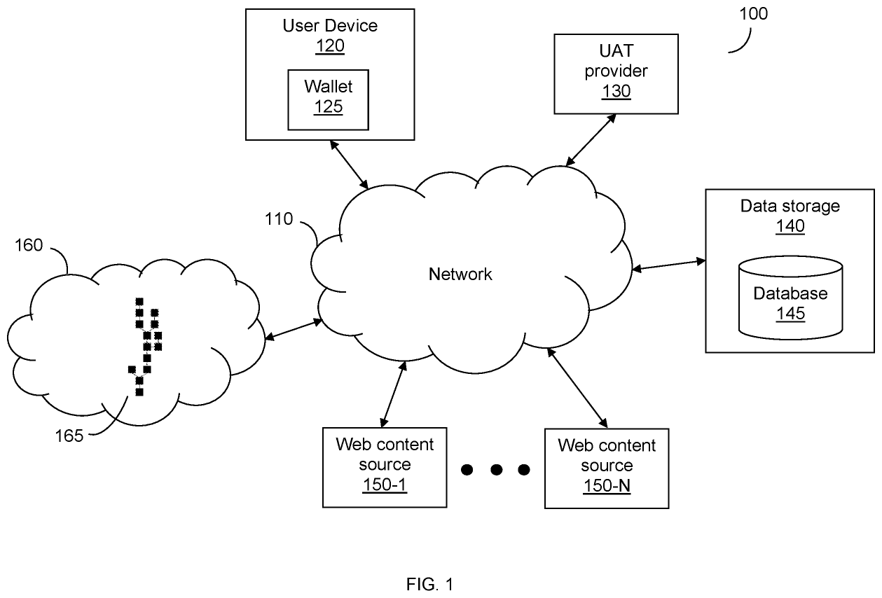

FIG. 1 shows an example network diagram 100 utilized to describe the various disclosed embodiments. In the example network diagram 100, a user device 120, a unique asset token (UAT) provider 130, a data storage 140, a plurality of web content sources 150-1 through 150-N (hereinafter referred to individually as a database 140 and collectively as databases 140, merely for simplicity purposes), and a blockchain network 160 communicate via a network 110.

The network 110 may be, but is not limited to, a wireless, cellular or wired network, a local area network (LAN), a wide area network (WAN), a metro area network (MAN), the Internet, the worldwide web (WWW), similar networks, and any combinations thereof.

The user device (UD) 120 may be, but is not limited to, a personal computer, a laptop, a tablet computer, a smartphone, a wearable computing device, or any other device capable of receiving and displaying media content. The user device is equipped with one or more input/output (I/O) devices (not depicted in FIG. 1) which can display or otherwise project media content associated with webpages or portions of webpages owned by the user of the user device 120.

As depicted in FIG. 1, the user device 120 includes a wallet 125. In this implementation, the wallet 125 may be a program stored and executed on the user device 120. In other implementations, the wallet 125 may be a device (not depicted in FIG. 1) connected to the user device 120. In yet other embodiments, the wallet 125 may be stored on another system (not depicted in FIG. 1) such as a server of an NFT platform or another server owned by a provider of UAT services. The wallet 125 stores ownership data used to access the media content of webpages represented in the database 145 such as, but not limited to, token ownership data, authentication credentials, and the like.

The UAT provider 130 is configured to at least encode webpages and create databases (e.g., a database 145) including nodes and webpage code as described herein. The UAT provider 130 may be further configured to provide media content associated with webpages to owners of UAT nodes in the database 145 as described herein.

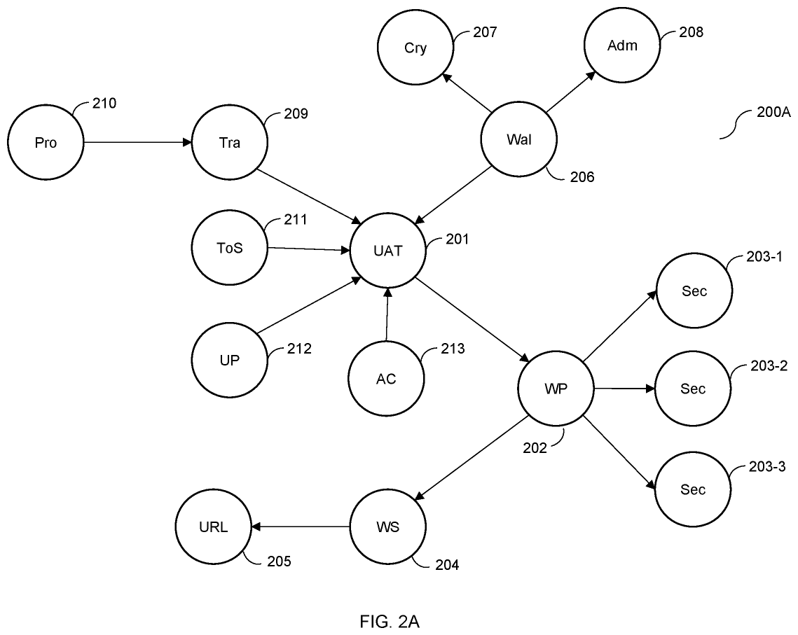

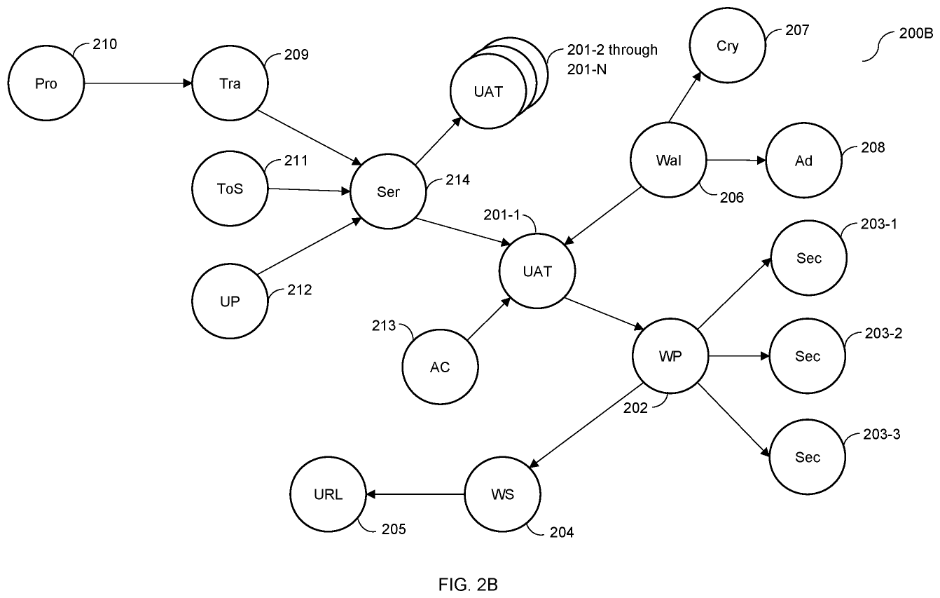

The data storage 140 stores a database 145 that is at least partially populated with code and nodes created by the UAT provider 130 as described herein. The database 145 stores nodes (not depicted in FIG. 1) connected to each other (e.g., via edges). The nodes at least include webpage nodes associated with respective webpages and UAT nodes associated with UATs defined with respect to content of the webpages. In an embodiment, the database 145 may be realized as a graph (e.g., a hypergraph such as a multi-tenant temporal hypergraph). An example illustration of nodes in the database 145 realized as a graph is described further below with respect to FIG. 2.

The web content sources 150 store content of webpages including, but not limited to, media content. Such content is encoded by the UAT provider 130 as described herein and stored in the database 145 in order to enable providing the appropriate content when an owner of a UAT (e.g., a user of the user device 120) requests to access the content associated with the UATs they own.

The blockchain network 160 includes multiple computing nodes (not shown), each computing node storing a copy of a blockchain 165. In various embodiments, the database 145 or a copy of the database 145 may be stored on the blockchain 165, thereby enabling the benefits of such blockchain use discussed above. To this end, in some embodiments, the UAT provider 130 may be configured to upload transactions to the blockchain 165 as the database 145 is updated. The transactions uploaded to the blockchain 165 may include a full copy of the database 145 or one or more changes to the existing copy of the database 145.

It should be noted that the network diagram 100 is merely an example, and that other combinations of networked components may be equally utilized without departing from the scope of the disclosure. Further, it should be noted that a|1| components illustrated in FIG. 1 are depicted as communicating via a single network 110 merely for simplicity, but that different networks or no networks may be used for different communications among the components without departing from the scope of the disclosure.

FIG. 2A is a non-limiting example visual depiction 200A of nodes in a database realized as a hypergraph.

The example visual depiction 200A includes various nodes connected to a UAT node 201. The UAT node 201 represents a tokenized version of a unique asset (not shown) such as, but not limited to, an NFT or PDT. The unique asset may be a digital or physical asset that is media content included in a webpage or is otherwise represented by media content included in the webpage such that the webpage can be encoded into portions of code (e.g., code in hypertext markup language) for projecting the media content.

In some embodiments, the UAT node 201 may further include transaction data indicating historical transactions involving the UAT represented by the UAT node 201 (e.g., transactions which resulted in modification of the database involving changing connections between the UAT node 201 and wallet nodes or owning entity nodes), the initial creation of the UAT node 201, both, and the like. Consequently, the UAT node 201 may also include a complete history of ownership of the UAT. Storing such historical data allows the UAT node 201 to serve as a proof of authenticity or otherwise as a proof of ownership history for the UAT represented by the UAT node 201.

The UAT node 201 is connected to a webpage (WP) node 202 representing a corresponding webpage tokenized via the hypergraph. In various embodiments, the UAT node 201 includes one or more portions of code created by encoding the corresponding webpage represented by the webpage node 202 connected to the UAT node 201. Such portions of code may include instructions in formats such as, but not limited to, cascading style sheets (CSS), Javascript, hypertext markup language (HTML), combinations thereof, and the like. In other embodiments (not shown), such portions of code may be stored in code nodes (not shown) which are distinct from the UAT node 201 and are connected to the UAT node 201, the webpage node 202, or both. Such portions of code can be provided to an authorized device, thereby allowing such an authorized device to use the portions of code to generate a view of the webpage including any applicable media content.

In some embodiments, the webpage node 202 may further be connected to multiple section nodes such as section (Sec) nodes 203-1 through 203-3. The section nodes 203-1 through 203-3 represent different sections of the webpage represented by the connected webpage node 202. By representing sections of webpages as distinct nodes, webpage tokenization may be realized in a more granular fashion, i.e., such that multiple tokens may be created for a single webpage and multiple owning entities may each effectively own a different portion of the same webpage. The portion of a webpage for a respective owning entity may be represented and rendered as a distinct webpage including the corresponding content owned by that entity.

The webpage node 202 may further be connected to a website (WS) node 204 representing the website including the webpage represented by the webpage node 202. The website node 204 may further be connected to other webpage nodes (not shown) representing various webpages of the website. Additionally, the website node 204 may be connected to a location node such as a uniform resource locator (URL) node 205 representing a URL associated with the webpage. In other embodiments (not shown), each webpage node may also be connected to a corresponding URL node indicating the location of the respective webpage on the Internet.

The UAT node 201 may further be connected to a node associated with an entity that owns the UAT of the UAT node 201 such as the wallet (Wal) node 206. The wallet node 206 represents and stores data indicating ownership of the UAT represented by the UAT node 201 such that the connection between the wallet node 206 and the UAT node 201 can be utilized to confirm ownership of the UAT by the owner of the wallet. The wallet node 206 may also optionally represent a wallet (e.g., the wallet 125, FIG. 1).

The wallet node 206, in turn, may be connected to one or more cryptocurrency (Cry) nodes 207, a wallet administrator (Adm) node 208, or both. The cryptocurrency nodes 207 may represent cryptocurrency owned by the owner of the wallet. Such cryptocurrency may be used to conduct transactions involving transfers of UATs such as using the cryptocurrency to purchase a UAT to be transferred to the wallet or receiving cryptocurrency as payment for such a UAT. The wallet administrator node 208 may be associated with an administrator of the wallet (e.g., the owner of the wallet or a third party entity who has been granted the right to act on behalf of the wallet owner), and may store data indicating policies related to use of the wallet.

In some implementations (not shown), multiple wallet administrator nodes may be connected to any given wallet node, and each administrator represented by one of the wallet administrator nodes may own a fractional share of the wallet. Each wallet administrator node may further include data indicating a percentage of ownership of the wallet by the administrator associated with the wallet administrator node. This percentage of ownership may further be connected to an accounting system (not shown), which may represent balances in any currency.

The UAT node 201 may further be connected to one or more nodes representing policies to be applied in relation to creation, use, or access of UAT nodes such as, but not limited to, a transfer node 209, a terms of service (ToS) node 211, a usage policy (UP) node 212, or a combination thereof.

The transfer node 209 may act as a minting contract, i.e., a smart contract defining policies for creation of UAT nodes for webpages (i.e., minting of webpages as UATs). To this end, the transfer node 209 may store code that, when executed, applies the rules of the policy to the creation of UAT nodes such as the UAT node 201. Such policies may include, but are not limited to, restrictions on the number of UATs which can be created (i.e., the number of UAT nodes which can be created) for a given webpage or portion thereof. As a non-limiting example, such a policy may limit the creation of NFTs for a given webpage to 100 NFTs total.

In some implementations, the transfer node 209 may further be connected to a provider (Pro) node 210 representing a provider of the UAT. Such a provider may be, but is not limited to, a creator of the UAT, a company representing the creator of the UAT, and the like. In this regard, the provider node 210 may serve as evidence of the originator of the UAT node 201.

The terms of service node 211 includes code that, when executed, applies the rules of one or more policies defining terms of service for a UAT. Such policies may require, for example, that a user to whom the UAT is transferred (e.g., a user of a wallet represented by a wallet node to which the UAT node will be connected) agree to terms of service before being granted ownership of or access to the UAT.

The usage policy node 212 includes code that, when executed, applies the rules of one or more policies defining restrictions on use of a UAT, access to the UAT, both, and the like. Such restrictions may include, but are not limited to, requiring that UATs not be shared for free, limiting the number of uses of a given UAT, and the like. In various embodiments, multiple usage policies (which may be represented by multiple usage policy nodes, not shown), may be applied to any given UAT or series of UATs. The usage policies may be defined by a platform for the UATs, a marketplace for the UATs, a provider of a UAT, or a combination thereof, depending on the implementation.

In a further embodiment, the usage policy represented by the usage policy node 212 may require an access code before using or accessing the UAT of the connected UAT node 201 in order to prevent unauthorized access. To this end, the UAT node 201 may also be connected to an access code (AC) node 213 representing an access code required to use or access the UAT. As a non-limiting example, before web content of the webpage represented by the webpage node 202 is provided, a user of the wallet represented by the wallet node 206 or other user indicated by the wallet node 206 may be required to enter the access code indicated by the access code node 213.

FIG. 2B is a non-limiting example visual depiction 200B of nodes in a database including a token series node. As depicted in FIG. 2B, the nodes of the database further include a UAT series (Ser) node 214. The UAT series node 214 may define a series of related UATs such as, but not limited to, music tracks of an album, art pieces in a collection, and the like.

The UAT series node 214 is connected to multiple UAT nodes including the UAT node 201-1 and other UAT nodes 201-2 through 201-N. As depicted in FIG. 2B, the series node 214 may be connected to any of the transfer node 209, the terms of service node 211, and the usage policy node 212, such that rules and policies defined in data of those nodes may be applied to all of the UATs represented by the UAT nodes 201-1 through 201-N. Accordingly, using series nodes such as the UAT series node 214 allows for defining policies for groupings of UATs rather than defining policies individually per UAT. As new UATs are added to a series (for example, by connecting new UAT nodes to the UAT series node 214), the policies for the UAT series node 214 may be automatically linked to their respective UAT nodes via the connections in the database.

Further, in another implementation (not depicted in FIG. 2B), additional policy-related nodes (e.g., additional transfer nodes, terms of service nodes, and/or usage policy nodes) may be connected to any or all of the UAT nodes 201-1 through 201-N such that, in addition to any policies applicable to all UATs in the series, each UAT may have its own policies applied.

It should be noted that FIGS. 2A and 2B depict various specific numbers of nodes, numbers of connections, types of nodes, and connections between different types of nodes for example purposes, but that the disclosed embodiments are not necessarily limited to the specific depiction of nodes and connections illustrated in FIG. 2. In particular, only one instance of many types of nodes are depicted in FIGS. 2A and 2B for simplicity purposes, but in various implementations multiple of each node may be included without departing from the scope of the disclosure. Further, the additional UAT nodes 201-2 through 201-N are depicted without connections to nodes other than the series node 214 merely for simplicity, and that, in various implementations, each of these UATs 201-2 through 201-N may be connected to other nodes.

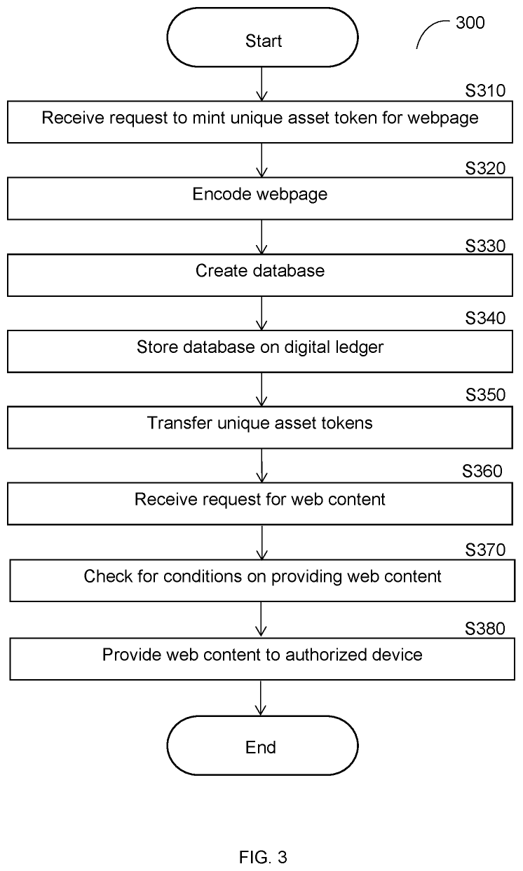

FIG. 3 is a flowchart illustrating a method for providing webpages as unique asset token (UAT) nodes according to an embodiment. In an embodiment, the method is performed by the UAT provider 130.

At S310, a request to mint a webpage as a UAT is received. The request may include, but is not limited to, information needed to access the website (e.g., a uniform resource locator, authentication credentials, etc.). The request may further include various restrictions to be applied to the UATs representing the webpage. Such restrictions may include, but are not limited to, terms of service, usage policies, access codes, combinations thereof, and the like. The minting process at least includes encoding all or a portion of the webpage as well as adding tokens for the webpage to a database as described further below.

The webpage is associated with one or more physical or digital assets and includes media content representing the associated assets. As a non-limiting example where the asset is a digital music track, the webpage associated with the asset may include music content of the digital music track, and may further include supplementary content such as text including lyrics to a song, album cover art, text including band biography information, and the like. As a non-limiting example where the asset is a physical comic book, the webpage associated with the asset may include scanned images showing pages and/or the cover of the comic book, and may further include supplementary content such as an author's or artist's signature.

At S320, the webpage is encoded into one or more portions of code. The portions of code include instructions that, when executed by a system (for example, at the user device 120, FIG. 1), causes the system to project media content (e.g., by rendering images or other visual content, projecting sound for audio content, combinations thereof, and the like). Accordingly, such code can be stored in a database (specifically, in nodes of the database) such that the appropriate code can be provided (e.g., to a user device) when the owner of the UAT representing the respective portion(s) of code requests to access the content, and execution of the code on a device of that owner allows for displaying or otherwise projecting the media content to that owner.

At S330, a database is created based on the encoded webpage. Creating the database may include creating a new database or adding to an existing database.

The created database includes nodes, and the portions of code of the encoded webpage are distributed among at least some of the nodes of the database. In an embodiment, the database at least includes webpage nodes and UAT nodes. Each webpage node is associated with a respective webpage and indicates at least a portion of the respective webpage that is represented by the node. Each UAT node represents a UAT indicating ownership of a webpage or portion thereof. Each UAT node is at least connected to one or more webpage nodes. In a further embodiment, the portions of code are distributed among the webpage nodes.

The UAT nodes represent tokens which indicate ownership of one or more non-interchangeable assets with respect to a webpage. Such assets may include, but are not limited to, books, albums, tracks, videos, movies, tickets (e.g., concert tickets), graphic novels, trading cards, representations thereof, combinations thereof, portions thereof, and the like. The unique assets represented by UATs in the database include media content of webpages which represents underlying digital or physical assets. The UAT nodes may further represent ownership of the underlying digital or physical assets.

The UATs include tokens representing non-interchangeable items such as, but not limited to, non-fungible tokens (NFTs), provenance and documentation tokens (PDTs), and the like. An NFT is a non-interchangeable token representing a digital item (i.e., a data item). A PDT is a non-interchangeable token representing a physical item. These tokens are non-interchangeable at least in that any given NFT or PDT is not necessarily equivalent to any other token of the same type, in other words, at least some NFTs represent different underlying digital items as compared to at least some other NFTs and likewise for PDTs. It should be noted that some UATs may be equivalent to each other without departing from the scope of the disclosed embodiments. As a non-limiting example, some UATs may be NFTs representing music tracks where some of those NFTs may represent the same music track and others may represent different music tracks, or each NFT may represent a distinct music track.

In some embodiments, multiple UAT nodes may be connected to a given webpage node, thereby establishing fractional ownership of the webpage, the underlying item represented by the webpage, or both. Such fractional ownership may include equal shares of ownership or may be defined as percentage ownerships that may differ among the multiple owners. In some implementations, when a UAT having multiple owners with fractional ownership (i.e., a UAT represented by a UAT node among multiple UAT nodes connected to a given webpage node) is transferred in exchange for a different item or currency, ownership of the item or currency may be distributed among the fractional owners according to their respective shares or percentage ownership.

As a non-limiting example, a unique asset may be a comic book depicted in images of a webpage, and the UAT node may represent ownership of the comic book, the webpage including the images of the comic book, or both. The webpage, including the images of the comic book, is encoded into portions of code, and the portions of code are included in a webpage node representing the webpage. Accordingly, a user that owns the UAT (for example, a user of a wallet that stores ownership information of the UAT) can access the webpage content because such content can be retrieved from the database and provided to a device of that user.

The nodes of the database may further include other types of nodes such as, but not limited to, wallet nodes, website nodes, location identifier nodes (e.g., uniform resource locator or URL nodes), section nodes, transfer nodes, terms of service nodes, usage policy nodes, content nodes, combinations thereof, and the like. Various types of nodes are depicted in and described with respect to FIG. 2 as discussed above.

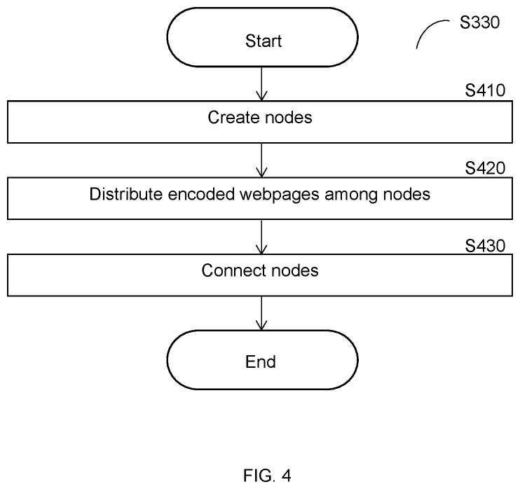

In an embodiment, the database may be created as discussed with respect to FIG. 4. FIG. 4 is a flowchart S330 illustrating a method for creating a UAT database according to an embodiment.

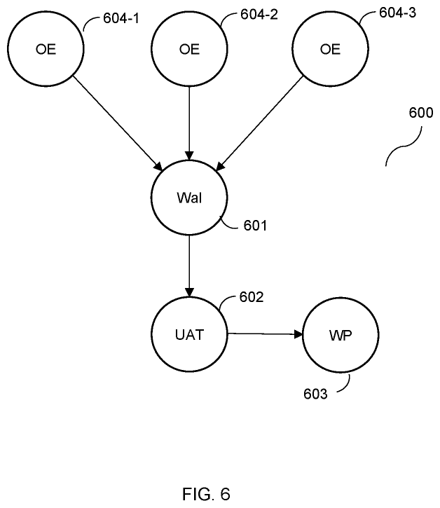

At S410, nodes of the database are created. In an embodiment, the nodes in the database at least include webpage nodes representing encoded webpages or portions thereof as well as UAT nodes representing UATs indicating ownership of respective webpages or portions thereof. In a further embodiment, the nodes of the database include nodes associated with entities who own the UATs such as wallet nodes representing wallets owned by such entities or owning entity nodes representing the entities themselves. In yet a further embodiment, the nodes of the database may further include any of the other nodes described above with respect to FIGS. 2A and 2B or below with respect to FIG. 6. It should be noted that the database may include other nodes without departing from the scope of the disclosure.

In some embodiments, the nodes of the database may further store historical data of transactions in which UATs are transferred. To this end, in a further embodiment, creating the nodes may further include storing initial transaction data in one or more of the nodes. As a non-limiting example, transaction data representing the initial creation of each UAT may be stored in the respective UAT node for each UAT when the UAT nodes are created. Alternatively the initial transaction data may be null data representing that no transactions involving the UAT have occurred yet.

At S420, the portions of code of encoded webpages are distributed among the created nodes. In an embodiment, the portions of code may be distributed into webpage nodes of the respective webpages which were encoded into those portions of code. As a non-limiting example, a first webpage may be encoded into a first portion of code and a second webpage may be encoded into a second portion of code such that the first portion of code is distributed to a first webpage node representing the first webpage and the second portion of code is distributed to a second webpage node representing the second webpage.

At S430, the created nodes are connected. In an embodiment, the created nodes are connected at least such that each UAT node is connected to a respective webpage node representing the webpage provided as a UAT. In a further embodiment, the created nodes may be connected such that each UAT node is also connected to a wallet node or owning entity node associated with the entity who owns the UAT. In another embodiment, the created nodes may be connected such that each UAT node is further connected to nodes for enforcing restrictions on use or access of the respective UAT such as, but not limited to, transaction nodes, terms of service nodes, usage policy nodes 212, access code nodes 213, combinations thereof, and the like.

Returning to FIG. 3, at optional S340, the database is stored on a digital ledger. In an embodiment, S340 may include uploading the database to a decentralized digital ledger such as a blockchain. As noted above, storing the database on a blockchain allows for ensuring the accuracy of the data in the database by providing an immutable record against which the database can be compared when making transfers, and storing the database on a decentralized ledger in addition to a centralized ledger allows for portability, i.e., the database may be transferred to a new digital ledger relatively easily. As a non-limiting example, the database may be stored as a side chain on a blockchain.

At optional S350, one or more of the UAT nodes are transferred to a new owner. In an embodiment, S350 may occur when a request to transfer the UAT nodes is received from a current owner of the UAT nodes. The request may indicate to transfer the UAT nodes immediately or upon meeting one or more conditions. The request may be received from a wallet of the current owner.

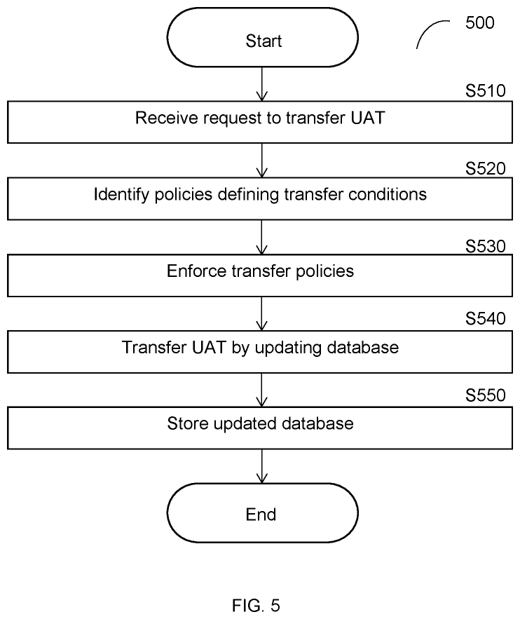

In an embodiment, transferring the UATs may include reconnecting the respective UAT nodes corresponding to those UATs. An example method for transferring UATs via the database is described further below with respect to FIG. 5.

At S360, a request to provide content of a webpage is received. The request may indicate, for example, the UAT associated with the webpage (e.g., a UAT represented by a UAT node connected to a webpage node of the webpage in the database). The request may further include other information for accessing the webpage content such as, but not limited to, authentication credentials, authorized devices or accounts (i.e., devices or accounts that are authorized to access the content), both, and the like.

In some embodiments, the request may be for content of multiple webpages. As a non-limiting example, a user may own multiple webpages as UATs and may wish to combine media content from these webpages into a single webpage and to view that content as a collection. Because the content from these webpages is encoded and reflected in discrete nodes of the database, these different portions of content can be incorporated into a single webpage, for example, using a predefined template into which the portions of code are inserted.

At optional S370, any conditions for providing the content are identified. Such conditions may be defined in data of nodes associated with the UAT node such as, but not limited to, usage policy nodes or terms of service nodes. To this end, in an embodiment, S370 may include scanning the database for nodes connected (either directly or indirectly, i.e., through other nodes) to the UAT node and identifying conditions defined in those nodes. The conditions are applied when providing the requested content and may be used to limit how the content is used or to deny access to the content entirely. The conditions may be set by different entities, for example, some conditions may be set by an operator of a UAT platform (e.g., an NFT platform), other conditions may be set by an originator of a UAT (e.g., an artist who created a work represented by an NFT or PDT), and yet other conditions may be set by an entity that provides the web-based content for tokenization (e.g., a record company, publisher webpage owner, etc.).

At S380, the requested content of the webpage is provided to an authorized device, i.e., a device authorized to access the content by the owner of the respective UATs associated with the webpage via the nodes of the database or a device used by a user of an authorized account indicated in the request. In an embodiment, S370 includes providing the respective portions of code through which the webpage is encoded to the authorized device. Because the portions of code of a webpage include instructions for projecting the media content of the webpage, the authorized device can execute the portions of code, thereby causing the authorized device to project media content (e.g., by rendering visual content or projecting audio content via a speaker).

In an embodiment, the conditions identified at S370 are applied. It should be noted that, in some implementations, when a condition defining whether content can be shared is not met, web content may not be provided at S380. As a non-limiting example, when a usage policy node associated with a UAT node representing a UAT includes data defining a condition limiting the number of times the UAT may be shared or viewed per day to 5 times per day and the UAT has already been shared or viewed 5 times in 24 hours, access to the UAT may be denied and the web content is not provided to the otherwise authorized device. Optionally, a notification indicating the failure to meet one or more conditions may be sent to the authorized device or to a user device associated with the user who owns the UAT.

FIG. 5 is an example flowchart 500 illustrating a method for transferring unique asset token nodes of webpages using a database according to an embodiment. In an embodiment, the method may be performed by the UAT provider 130, FIG. 1.

At S510, a request to transfer a unique asset token (UAT) is received. The request indicates information to be used for determining how to alter a database storing nodes in order to realize the transaction such as, but not limited to, an identifier of the UAT being transferred, an identifier of a first user from whom the UAT is being transferred, an identifier of a second user to whom the UAT is being transferred, identifiers of wallets of such users, identifiers of tokens of any of the foregoing, combinations thereof, and the like.

At optional S520, policies defining any potential transfer conditions on transferring the UAT are identified. Such conditions may be defined in data included in, for example, nodes of the database storing the UAT node representing the UAT. To this end, S520 may include scanning a database including a UAT node representing the UAT to be transferred for any nodes defining policies related to transferring the UAT such as, but not limited to, a transfer node or a terms of service node connected to such a UAT node or to a UAT series node of a UAT series the UAT belongs to. In an example implementation, the policies related to transferring the UAT may include a requirement that the user to which the UAT node is transferred must accept terms of service for the transferred UAT.

At optional S530, the policies defining the applicable transfer conditions identified at S520 are enforced. In the example implementation where the policies require the new owner to accept terms of service, S530 may include presenting the terms of service (e.g., by sending a notification for display on a user device of the new owner) and receiving a response indicating whether the user accepted the terms of service. In some implementations, if requirements of the policies related to transfers are not met, the UAT may not be transferred to the new owner.

At S540, the database is updated in order to transfer the UAT. In an embodiment, S540 includes modifying connections in the database including the UAT node representing the UAT such that the UAT is connected to a different node associated with the owning entity (e.g., a different wallet node or a different owning entity node).

More specifically, the transferred UAT may be initially connected to a node associated with the current owner (e.g., a wallet node associated with a wallet owned by the current owner of the UAT nodes or an owning entity node representing the current owner) and then reconnected to a node associated with the new owner instead. The database including the reconnected nodes is therefore updated.

In a further embodiment, updating the database may further include updating historical data stored in nodes of the database related to transactions. As a non-limiting example, historical data of transactions in which a UAT was transferred may be stored in a UAT node corresponding to the UAT such that updating the database may include adding a new entry to the historical data stored in the UAT node.

At optional S550, the updated database may be stored in a centralized data storage, a decentralized ledger such as a blockchain, or both.

FIG. 6 is an example visual depiction 600 of nodes in a database utilized to describe implementing a multi-ownership wallet.

As depicted in FIG. 6, a wallet (Wal) node 601 is connected to a UAT node 602, which in turn is connected to a webpage (WP) node 603. Additionally, the wallet node 601 is connected to multiple owning entity (OE) nodes 604-1 through 604-3. Each owning entity node 604 represents a respective entity who owns a portion of the wallet such that each entity also owns a portion of the UAT represented by the UAT node 602 and the webpage of the webpage node 603.

In an implementation such as the implementation depicted in FIG. 6, the owning entities represented by respective owning entity nodes 604 own fractional shares of the wallet represented by the wallet node 601 as well as of the UATs represented by any UAT nodes (e.g., the UAT node 602) connected to the wallet node 601. Such fractional shares may be divided equally, i.e., such that each owning entity owns an equal portion of the wallet represented by the wallet node 601, or may be unequal (as a non-limiting example, based on an amount contributed by each owning entity). Such fractional ownership allows multiple entities to share ownership of a single UAT. Access to the UAT represented by the UAT node 602 may be restricted for the owning entities, for example using nodes which restrict access to or use of the UAT nodes 602 discussed above.

In some implementations, the fractional shares can be utilized to easily and automatically distribute proceeds from any exchanges involving the UAT represented by the UAT node 602. As a non-limiting example, when the owning entities represented by the owning entity nodes 604-1 through 604-3 have equal fractional shares and the UAT represented by the UAT node 602 is sold for 3 Bitcoin, each owning entity is distributed 1 Bitcoin. The distribution may be realized by adding the distributed Bitcoins to the wallet represented by the wallet node 601 or by distributing the 1 Bitcoin per owning entity to individual wallets (not represented by nodes depicted in FIG. 6) owned by the respective owning entities.

As another non-limiting example, the fractional shares can be utilized to tokenize ownership in or sponsorship of a museum, where the fractional shares are distributed to users who contributed to funding the museum. As yet another non-limiting example, the fractional shares may each represent a ticket to an event sponsored using proceeds obtained via purchasing of the fractional shares.

In various implementations, wallets may belong to one of multiple potential types of wallets. Such potential types of wallets may include, but are not limited to, ownership, participatory, marketplace, website, and the like. The wallet nodes of different types of wallets may each indicate the wallet type of the corresponding wallet such that the wallet node further represents the type of relationship between the wallet node and any UAT nodes connected to the wallet node. For example, an ownership type of wallet may represent that certain UATs are owned by a user of the wallet, a participatory type of wallet may represent that a user of the wallet is entitled to proceeds from transactions involving certain UATs (e.g., royalties from sales of the UAT), a marketplace type of wallet may represent that the owner of the wallet is an owner of a marketplace that currently offers the UATs for sale until the UATs are sold to individuals, and a website type of wallet may represent a website in which a marketplace is embedded, thereby incentivizing the website owner to drive traffic to the marketplace. To this end, a wallet node may include code for implementing policies specific to the applicable type of wallet.

It should be noted that a limited set of nodes and connections is depicted in FIG. 6 merely for simplicity purposes, but that additional nodes may be equally utilized without departing from the scope of the disclosure, and those nodes may be connected in any combination or organization in accordance with the disclosed embodiments. Such additional nodes may include, but are not limited to, any of the nodes depicted in FIGS. 2A and 2B. Likewise, although owning entity nodes are not depicted in FIGS. 2A and 2B, owning entity nodes may be implemented in graphs like the graphs depicted in FIGS. 2A and 2B without departing from the scope of the disclosure.

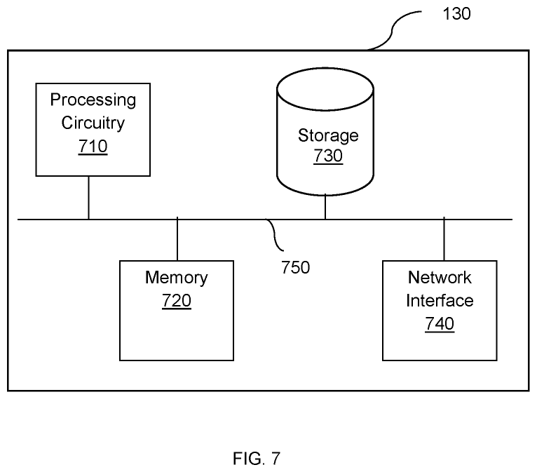

FIG. 7 is an example schematic diagram of a unique asset token provider 130 according to an embodiment. The unique asset token provider 130 includes a processing circuitry 710 coupled to a memory 720, a storage 730, and a network interface 740. In an embodiment, the components of the unique asset token provider 130 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 720 may be volatile (e.g., random access memory, etc.), non-volatile (e.g., read only memory, flash memory, etc.), or a combination thereof.

In one configuration, software for implementing one or more embodiments disclosed herein may be stored in the storage 730. In another configuration, the memory 720 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 710, cause the processing circuitry 710 to perform the various processes described herein.

The storage 730 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 740 allows the unique asset token provider 130 to communicate with, for example, the user device 120, the data storage 140, the web content sources 150, the blockchain network 160, combinations thereof, and the like.

It should be understood that the embodiments described herein are not limited to the specific architecture illustrated in FIG. 7, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for encoding assets owned via tokens as webpages, comprising:
encoding a webpage into at least one portion of code, wherein the webpage is associated with at least one unique asset, wherein each of portion of code causes projection of media content corresponding to the at least one unique asset when executed;
creating a database including a plurality of nodes, the plurality of nodes including a plurality of webpage nodes and a plurality of unique asset token (UAT) nodes, wherein the encoded at least one portion of code of the webpage is stored among a portion of the plurality of nodes, wherein a first webpage node of the plurality of webpage nodes is associated with the webpage, wherein at least one first UAT node of the plurality of UAT nodes is connected to the first webpage node, wherein each of the at least one first UAT node corresponds to one of the at least one unique asset; and
providing the at least one portion of code to a device authorized by an owner of the at least one first UAT node.

2. The method of claim 1, wherein the at least one unique asset includes a non-fungible token (NFT), further comprising:
storing the database on a blockchain.

3. The method of claim 1, wherein the at least one unique asset includes a provenance and documentation token (PDT), wherein the at least one unique asset includes a physical item, wherein the PDT includes data indicating an ownership history of the physical item.

4. The method of claim 1, wherein the first webpage node includes the encoded at least one portion of code of the webpage.

5. The method of claim 1, wherein the webpage has at least one section, wherein the plurality of nodes further includes at least one first section node, wherein each first section node is connected to the first webpage node, wherein each first section node includes one of the at least one portion of code.

6. The method of claim 1, wherein the plurality of nodes further includes a plurality of website nodes, wherein each website node is associated with a respective website of a plurality of websites, wherein each webpage node is connected to one of the website nodes in the database.

7. The method of claim 1, wherein each UAT node stores historical transaction data for transactions involving transfer of at least one of the at least one unique asset.

8. The method of claim 1, wherein the plurality of nodes further includes a plurality of transfer nodes, wherein each transfer node defines permissible transfers of at least a portion of the UAT nodes.

9. The method of claim 1, wherein the plurality of nodes further includes a plurality of terms of service nodes, wherein each terms of service node is connected to at least one UAT node of the plurality of UAT nodes, wherein each terms of service node indicates terms of service for the connected at least one UAT node, wherein a new owner of a first UAT node of the plurality of UAT nodes must accept the terms of service for each terms of service node connected to the first UAT before ownership of the first UAT node is transferred to the new owner.

10. The method of claim 1, wherein the plurality of nodes further includes a plurality of usage policy nodes, wherein each usage policy node is connected to at least one UAT node of the plurality of UAT nodes, wherein each usage policy node defines at least one restriction on use of the connected at least one UAT node.

11. The method of claim 10, wherein a first usage policy node of the plurality of usage policy nodes indicates an access code, wherein the at least one restriction on use defined by the first usage policy node includes a requirement to authenticate using the access code.

12. The method of claim 1, wherein the plurality of nodes further includes a wallet node connected to a plurality of owner entity nodes, the wallet node further being connected to at least one UAT nodes of the plurality of UAT nodes.

13. A non-transitory computer readable medium having stored thereon instructions for causing a processing circuitry to execute a process, the process comprising:
encoding a webpage into at least one portion of code, wherein the webpage is associated with at least one unique asset, wherein each of portion of code causes projection of media content corresponding to the at least one unique asset when executed;
creating a database including a plurality of nodes, the plurality of nodes including a plurality of webpage nodes and a plurality of unique asset token (UAT) nodes, wherein the encoded at least one portion of code of the webpage is stored among a portion of the plurality of nodes, wherein a first webpage node of the plurality of webpage nodes is associated with the webpage, wherein at least one first UAT node of the plurality of UAT nodes is connected to the first webpage node, wherein each of the at least one first UAT node corresponds to one of the at least one unique asset; and
providing the at least one portion of code to a device authorized by an owner of the at least one first UAT node.

14. A system for encoding assets owned via tokens as webpages, comprising:
a processing circuitry; and
a memory, the memory containing instructions that, when executed by the processing circuitry, configure the system to:
encode a webpage into at least one portion of code, wherein the webpage is associated with at least one unique asset, wherein each of portion of code causes projection of media content corresponding to the at least one unique asset when executed;
create a database including a plurality of nodes, the plurality of nodes including a plurality of webpage nodes and a plurality of unique asset token (UAT) nodes, wherein the encoded at least one portion of code of the webpage is stored among a portion of the plurality of nodes, wherein a first webpage node of the plurality of webpage nodes is associated with the webpage, wherein at least one first UAT node of the plurality of UAT nodes is connected to the first webpage node, wherein each of the at least one first UAT node corresponds to one of the at least one unique asset; and
provide the at least one portion of code to a device authorized by an owner of the at least one first UAT node.

15. The system of claim 14, wherein the at least one unique asset includes a non-fungible token (NFT), further comprising:
storing the database on a blockchain.

16. The system of claim 14, wherein the at least one unique asset includes a provenance and documentation token (PDT), wherein the at least one unique asset includes a physical item, wherein the PDT includes data indicating an ownership history of the physical item.

17. The system of claim 14, wherein the first webpage node includes the encoded at least one portion of code of the webpage.

18. The system of claim 14, wherein the webpage has at least one section, wherein the plurality of nodes further includes at least one first section node, wherein each first section node is connected to the first webpage node, wherein each first section node includes one of the at least one portion of code.

19. The system of claim 14, wherein the plurality of nodes further includes a plurality of website nodes, wherein each website node is associated with a respective website of a plurality of websites, wherein each webpage node is connected to one of the website nodes in the database.

20. The system of claim 14, wherein each UAT node stores historical transaction data for transactions involving transfer of at least one of the at least one unique asset.

21. The system of claim 14, wherein the plurality of nodes further includes a plurality of transfer nodes, wherein each transfer node defines permissible transfers of at least a portion of the UAT nodes.

22. The system of claim 14, wherein the plurality of nodes further includes a plurality of terms of service nodes, wherein each terms of service node is connected to at least one UAT node of the plurality of UAT nodes, wherein each terms of service node indicates terms of service for the connected at least one UAT node, wherein a new owner of a first UAT node of the plurality of UAT nodes must accept the terms of service for each terms of service node connected to the first UAT before ownership of the first UAT node is transferred to the new owner.

23. The system of claim 14, wherein the plurality of nodes further includes a plurality of usage policy nodes, wherein each usage policy node is connected to at least one UAT node of the plurality of UAT nodes, wherein each usage policy node defines at least one restriction on use of the connected at least one UAT node.

24. The system of claim 23, wherein a first usage policy node of the plurality of usage policy nodes indicates an access code, wherein the at least one restriction on use defined by the first usage policy node includes a requirement to authenticate using the access code.

25. The system of claim 14, wherein the plurality of nodes further includes a wallet node connected to a plurality of owner entity nodes, the wallet node further being connected to at least one UAT nodes of the plurality of UAT nodes.
